(19) United States
(12) Patent Application Publication
(10) Pub. No.: US 2009/0292941 A1
(43) Pub. Date: Nov. 26, 2009

(54) PROOF-GUIDED ERROR DIAGNOSIS (PED) BY TRIANGULATION OF PROGRAM ERROR CAUSES

(75) Inventors: Malay K. Ganai, Plainsboro, NJ (US); Gogul Balakrishnan, Plainsboro, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/331,243

(22) Filed: Dec. 9, 2008

Related U.S. Application Data
(60) Provisional application No. 61/055,165, filed on May 22, 2008.
(60) Provisional application No. 61/058,305, filed on Jun. 3, 2008.

(51) Int. Cl. G06F 11/07

(52) U.S. Cl. 714/2; 714/E11.023

(57) ABSTRACT

Systems and methods are disclosed for performing error diagnosis of software errors in a program by from one or more error traces, building a repair program containing one or more modified program semantics corresponding to fixes to observed errors; encoding the repair program with constraints, biases and priortization into a constraint weighted problem; and solving the constraint weighted problem to generate one or more repair solutions, wherein the encoding includes at least one of: a) constraining one or more repairs choices guided by automatically inferring one or more partial specifications of intended program behaviors and program structure; b) biasing one or more repair choices guided by typical programming mistakes; and c) prioritizing the repair solutions based on error locations and possible changes in program semantics.

This application claims priority to Provisional Application Ser. No. 61/055,165, filed May 22, 2008 and to Provisional Application Ser. No. 61/058,305, filed Jun. 3, 2008, the contents of which are incorporated by reference.

### BACKGROUND

Model checking is one of the most successful automated techniques used to identify bugs in software and hardware. One of the advantages of model checking is that it provides an error trace, i.e., a concrete trace in the program that shows how the error state is reachable (i.e., how the bad behavior manifests). Such error traces can be very long and complex, and therefore, it is quite cumbersome and time consuming to manually examine the trace (i.e., debug) to identify the root cause of the error. In several cases, a bug may be due to problems in more than one statement (error-sites) that are quite far apart in the error trace. Further, it is very hard to identify the root cause of an error just by looking at a single error trace.

Error diagnosis is the process of identifying the root causes of program failures. Several error diagnosis techniques have been proposed in the recent past. For earlier works, one can find an excellent survey here. One problem faced by conventional error diagnosis techniques is the lack of a “golden specification” to compare against the behavior of a buggy program, and there are too many error sites for the tool to consider. Previous methods rely on availability of correct traces or derive them explicitly using model checking tools. The differences between error and correct traces are used to infer the causes of the errors. Most often these differences do not provide an adequate explanation of the failures. Error diagnosis is a time-consuming process. In general, it is hard to automate error diagnosis due to the unavailability of a full “golden” specification of the system behavior in realistic software development.

In model-checking based methods, the correct traces are obtained by re-executing the model checker with additional constraints. Similarities and differences in correct traces (also referred to as positives) and error traces (negatives) are analyzed transition by transition to obtain the root causes. These methods are in general limited by the scalability of the model checker. Further, the differences between positive and negative traces do not always provide a good explanation of the failure.

In program repair approaches and error correction, fault localization is achieved by introducing non-deterministic repair solutions in a modified system, and using a model checker to obtain a set of possible causes for the symptoms. Such an approach though have been successful for a few cases, in general they fail to pinpoint the real causes.

In another work based on static analysis, path-based syntactic-level weakest pre-condition computation is used to obtain the minimum proof of infeasibility for the given error trace. This method does not require correct trace, and does not use expensive model checking. This causal analysis provides an infection chain of the defect (i.e., relevant statements through which the defect in the code propagates), and not necessarily the root cause of the error.

Test-based error diagnosis methods rely on availability of good test-suite with large successful executions. The error traces are compared with the correct traces to pin-point the possible causes of the failure.

Delta debugging is an automatic experimental method to isolate failure causes. It requires two programs runs, one run where the failure occurs, and another where it does not. The subset of differences between the two is applied on the non-erroneous run to obtain the failure run. Such differences are then classified as causes of the problem. This method is purely empirical, and is different from formal or static analysis. Also, it may require a large number of tests to find a difference that pinpoints the error-site.

In game-theoretic based approaches, error trace is partitioned into two segments “fated” and “free”: “fated” being controlled by the environment forcing the system to error, and “free” being controlled by system to avoid the error. Fated segments manifest unavoidable progress towards the error while free segments contain choices that, if avoided, can prevent the error. This approach is significantly more costly than a standard model checking.

### SUMMARY

In one aspect, a method of diagnosing software errors in a computer program includes building a repair program from one or more error traces where the repair program contains one or more modified program semantics corresponding to repair choices. The repair program building can include constraining one or more repairs choices guided by automatically inferring one or more partial specifications of intended program behaviors and program structure; biasing one or more repair choices guided by typical programming mistakes; or prioritizing the repair solutions based on error locations and possible changes in program semantics. The system includes encoding the repair program with constraints and biases into a constraint weighted problem; and solving the constraint weighted problem to obtain one or more repair solutions.

In another aspect, a system to diagnose software errors includes a processor; and a data storage device coupled to the processor to store computer readable code to encode a repair program with constraints, biases and priortization into a constraint weighted problem; and solving the constraint weighted problem to generate one or more repair solutions, wherein the encoding includes at least one of: constrain one or more repairs choices guided by automatically inferring one or more partial specifications of intended program behaviors and program structure; bias one or more repair choices guided by typical programming mistakes; and prioritize the repair solutions based on error locations and possible changes in program semantics.

In yet another aspect, a repair-based proof-guided error diagnosis (PED) framework provides a first-line attack to triangulate the root causes of the errors in programs by pin-pointing possible error-sites (buggy statements), and suggesting possible repair fixes. The framework does not need a complete system specification. Instead, the system automatically “mines” partial specifications of the intended program behavior from the proofs obtained by static program analysis for standard safety checkers. The framework uses these partial specifications along with the multiple error traces provided by a model checker to narrow down the possible error sites. It also exploits inherent correlations among the program statements. To capture common programming mistakes, it directs the search to those statements that could be buggy due to simple copy-paste operations or syntactic mistakes such as using ≦ instead of <. To further improve debugging, it prioritizes the repair solutions.

In another aspect, a method diagnoses software errors includes guiding program error diagnosis by modifying untrusted code using syntactic closeness of an operator mapping; determining one or more weighted repair solutions; applying a constraint solver to select one or more repair solutions; and ranking the repair solutions for debugging of the code.

In yet another aspect, a method diagnoses software errors includes guiding program error diagnosis using proofs and counter-examples to segregate trusted and untrusted code; modifying untrusted code to eliminate errors without affecting the proofs; applying a constraint solver to select one or more repair solutions; and ranking the repair solutions for debugging of the code.

In yet another aspect, a method to diagnose software errors includes guiding program error diagnosis by modifying untrusted code using syntactic closeness of an operator mapping; in parallel guiding program error diagnosis using proofs and counter-examples to segregate trusted and untrusted code and modifying untrusted code to eliminate errors without affecting the proofs; determining one or more weighted repair solutions; applying a constraint solver to select one or more repair solutions; and ranking the repair solutions for debugging of the code.

Advantages of the preferred embodiment may include one or more of the following. The system automates the error diagnosis by locating the probable error-sites (ranking them based on relevance), and provide a first-line attack to triangulate the root cause. Advantages can also include: (a) For standard checkers (i.e., non functional-checkers) such as array bound violation and null pointer checks, the error-sites are potentially easier to locate as they are independent of specific program/design application. (b) Obtaining multiple error traces from a state-of-the-art model checking tool is fairly automated. (c) Presence of an error often results in violation of many checkers, thereby, potentially making the localization more accurate when those symptoms are also taken into consideration. (d) Proofs obtained from static analysis phase provide the program slices that can be “trusted”. (e) Many errors are caused due to syntactic mistakes such as using ‘<’ instead of ‘<=’. By giving preference to such operator “syntactic closeness”, one can improve the error localization. Assuming the “trusted code” as reliable, the system derives possible repair solutions using a constraint solver. Using this framework, a programmer can fix the code by reviewing only a few error sites before moving to next phase of time-consuming debugging.

Other advantages of the preferred embodiment may include the following. The proof-guided error diagnosis allows faster and more accurate debugging of erroneous programs. The system derives “trusted code” based on properties proved and invariants generated by static analyzer to guide the error diagnosis. Such usage provides better scalability than the model checking based methods. The instant method analyses several error traces generated by a model checking tool. This helps pinpoint the root causes of errors and help faster debugging overall. The system catches syntactic mistakes such as during copy-paste operation or boundary cases in loop terminating conditions are often made by programmers. Syntactic closeness of operators is used to prioritize the error-sites, thereby, provide more useful solutions. The system can question the reliability of the “trusted code” for some cases, when the system can not derive any repair solution.

### BRIEF DESCRIPTION OF THE DRAWINGS

FIG. 1A shows an exemplary F-SOFT framework.

FIG. 1B shows an exemplary process for automated error diagnosis.

FIG. 1C shows an exemplary repair-based proof-guided automated error diagnosis.

FIG. 2(a) shows an exemplary buggy code, and FIG. 2(b) shows the same code with checkers.

FIG. 3 is an exemplary error trace showing the violation of the property checker P2 of FIG. 2(b).

FIG. 4 shows an exemplary repair program for the error trace shown in FIG. 3.

FIG. 5 shows an exemplary process to localize an error.

FIG. 6 shows an example of reachable states, error projection and safety projection of a given property.

### DESCRIPTION

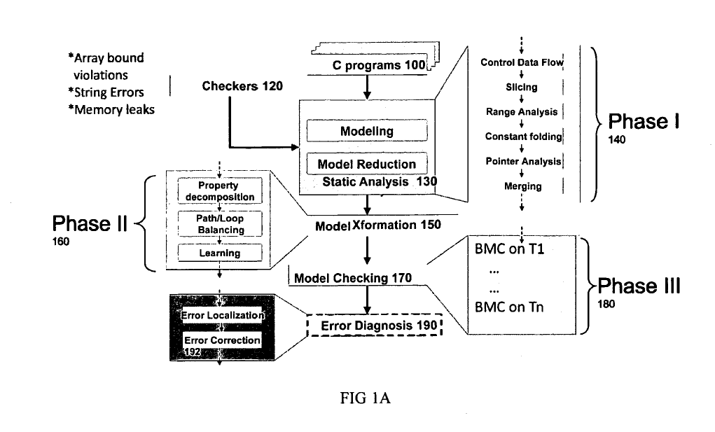

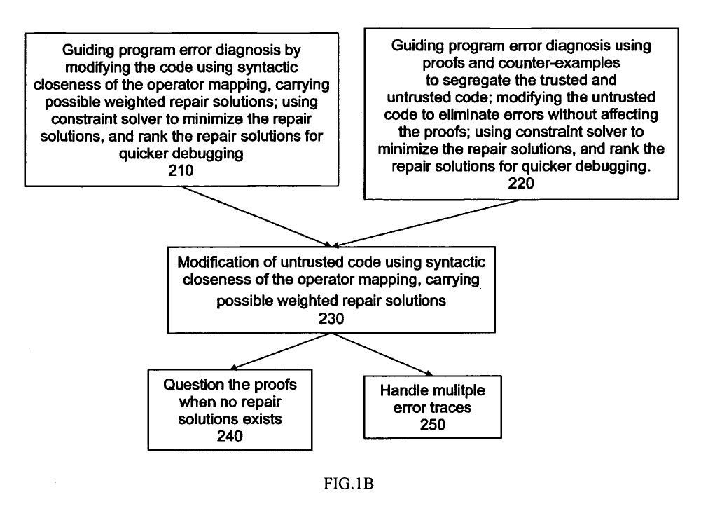

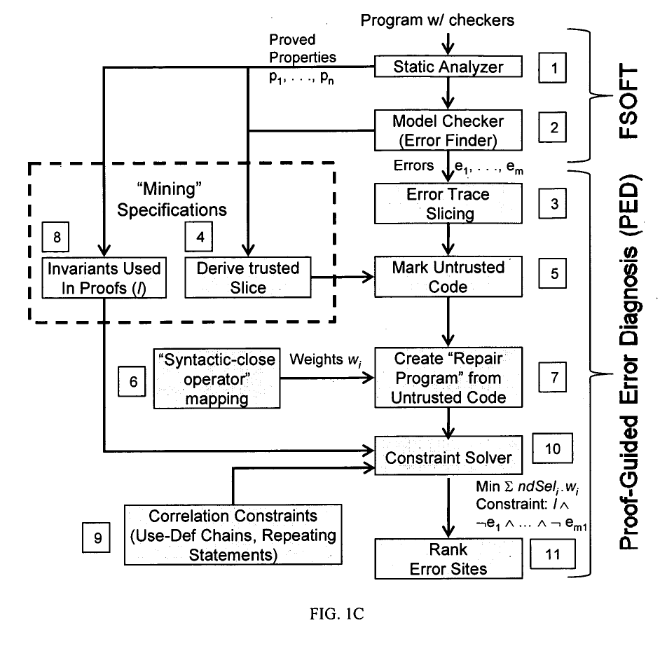

FIG. 1A shows an exemplary F-SOFT framework. In this framework, software such as C programs 100 to be tested against standard safety checkers 120 are provided to a static analyzer 130 which performs modeling and model reduction. In Phase I 140 which is detailed below, the analyzer determines control data flow, slicing, range analysis, constant folding, pointer analysis, and code merging, among others. The static analyzer 130 receives input from code checkers 120 comprising checks for array boundary violations, string errors, and memory leaks, among others. The annotated program with checkers is analyzed by the static analyzer, which uses various dataflow algorithms ranging from simple constant folding to more complex numerical analysis algorithms such as intervals, octagons, polyhedra, and disjunctive numerical domains to compute state invariants for all the statements in the program. The property checkers for the safety properties that are proved by the static analyzer are pruned away, and the resulting program is provided to a model transformer 150, which performs property decomposition, path/loop balancing, and learning, among others. The framework also includes a model checker 170 which provides Phase III 180 where it performs bounded model checking to determine if any of the remaining safety properties are violated. If the model checker finds any violations, it generates an error trace showing how the property is violated. The error trace generated by the model checker is sliced with respect to the variables in the violated property, and the sliced trace is shown to the user. Next, error diagnosis is generated in module 190. This can include error localization operations 192.

FIG. 1B shows an exemplary process for error diagnosis. In 210, the process guides program error diagnosis by modifying code using syntactic closeness of operator mapping. The process also carries possible weighted repair solutions and applies a constraint solver to minimize the number of repair solutions. The process also ranks the repair solutions so that programmers can fix bugs faster.

A parallel operation can be performed in 220. In this operation, the process guides program error analysis by proofs and counter-examples to segregate trusted and untrusted code. The untrusted code is modified to eliminate errors without affecting the proofs. Next, constraint solver is applied to to minimize the number of repair solutions. The process also ranks the repair solutions so that programmers can fix bugs faster.

From either 210 or 220, the process of FIG. 1C modifies the untrusted code using syntactic closeness of the operator mapping and applies possible solutions. These solutions are weighted repair solutions to prioritize bugs.

In 230, when no repair solutions can be determined, the process checks the correctness of the proofs or alternatively alerts the programmers to assist in reviewing the trusted code. In 250, the process handles multiple error traces.

FIG. 1C shows an exemplary error diagnosis flow. Given a program with multiple checkers, a static analyzer (block 1) is used to obtain proofs of a set of non-violable properties. The properties that can not be proved (i.e., unresolved) are passed on to a model checker or an error finding tool (block 2). The model checker produces counterexamples of properties that are indicative of program errors. Corresponding to the properties with counter-examples such as eⱼ, . . . ,eₘ, the process obtains a slice of relevant code Se (block 3). Similarly, corresponding to the proved/unresolved properties pⱼ, . . . ,pₙ, the system derives slice(s) of the relevant code Sₜ that is/are trusted (block 4). The process then marks the code Sel_{St} as un-trusted code (block 5). The system annotates (block 7) the un-trusted code with weighted repair solutions, either chosen non-deterministically, or guided by syntactic-close operator mapping (block 6), or both. The system then creates a repaired program from the untrusted code (block 7). A constraint solver (block 10) adds optimization criteria that minimize the number of possible error-sites. The constraint solver can receive input such as invariants used in Proofs (block 8) and correlation constraints (block 9). The system ranks the possible repair solutions (block 11) to help programmer debug the error symptoms with greater confidence.

In one embodiment, for an error trace, the system of FIG. 1C creates a repair program R. The behavior of statements can be modified in R, and the behavior can be controlled via selector variables. The embodiment analyzes the repair program to identify changes to R, subject to the requirement that the number of changes is small and the changes to R should avoid error. The embodiment can improve the diagnosis by mining specifications from static analysis and by ranking the repair options, among others.

The repair-based proof-guided error diagnosis (PED) framework of FIGS. 1B-1C assists a programmer in prioritizing or pin-pointing the root causes of program errors reported by model checkers. In such a repair-based approach (also, referred as replacement diagnosis), the buggy program is first modified to obtain a repair program, where statements can update the program state non-deterministically and control statements can branch non-deterministically as well, and then analysis is carried out to identify a (small) set of changes in the repair program (i.e. repair-fixes) that are necessary to prevent the error. Such an approach, in general, produces a large set of possible repair solutions.

The instant system improves such replacement diagnosis by identifying the most relevant repair solutions in the following ways:

Mining Partial Specifications: A complete specification of the intended program behavior is not needed. Instead, the system automatically extracts the partial specification of the intended behavior from the results of static analysis. In many cases, static program-analysis algorithms can prove that standard safety checkers, such as array-bound violations checker and null-pointer dereferences checker, can not be violated for all possible executions of the program. In such cases, the system extracts the invariants relevant for the proofs efficiently and use them as partial specification of the intended behavior of the program. For more restrictive repair solutions, the system also identifies the program statements that are relevant for the proofs and mark them as “trusted”. The idea is not to modify these statements in repair program, and restrict the search for error sites to untrusted program statements.

Syntactic Closeness: Significant number of errors in software are caused due to copy-paste operations. Further, many errors are caused due to syntactic mistakes such as using ≦ instead of <. The system gives preferences to “syntactic closeness” of operators and expressions to improve error localization. One implementation uses a library of “syntactically close” operators. For example, programmers commonly make typical mistakes: < instead of ≦. Additionally, instead of “ndSel₂?ndRes₂:(i≦n)” in repair program, the process restricts the search to most probable causes such as:

(ndSel k==3)?(i<n):

((ndSel k==2)?(i>=n):

((ndSel k==1)?(i>n):(i<=n)))

Correlation: The system also exploits the inherent correlation among the statements occurring in the use-def chains and statements corresponding to the unrolling of the loop body in an error-trace to reduce the set of repair solutions.

Multiple Error Traces: Presence of a bug often results in violation of many checkers. By taking an intersection of the repair solutions corresponding to error traces for the violation of different checkers, the system reduces the set of possible error-sites, which improves debugging.

Ranking: Several ranking criteria can be used for the repair solutions, such as giving preferences to minimal changes in the repair program, so that the user only has to examine the most relevant fixes.

In one implementation, the PED tool is provided as a plug-in module to a software verification framework F-Soft that works on C programs. It uses a combination of static analysis and model checking techniques to identify array out-of-bound violations, null-pointer dereferences, improper usage of C String API, among others.

Using the PED tool, a programmer can fix the code by reviewing only the prioritized repair solutions before moving to next phase of time-consuming debugging. The PED tool has been tested on a set of publicly available benchmarks, and buggy statements can easily be found by manual debugging of a handful of repair solutions.

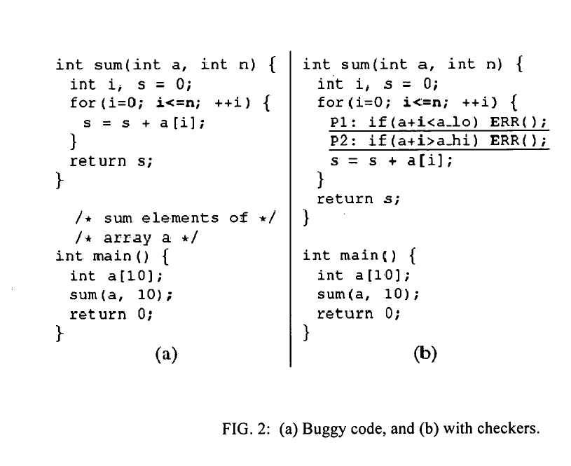

Consider the function sum shown in FIG. 2(a). It computes the sum of the elements in array a, which is of size n. The function has an array out-of-bounds error because the loop-terminating condition is i≦n (in bold) instead of i<n.

As a first step, a given program is annotated with checks for the violation of safety properties that are of interest to the user. A safety property is a pair S, φ, where S is a label in the program and φ is an assertion on the states that can reach the label S. A safety property is violated if an execution of the program reaches label S with a state that does not satisfy the assertion φ. For a safety property S,φ, the statement “if( [symbol] φ) ERR( );” is inserted at label S in the program, where [symbol] φ is the logical negation of φ, and ERR( ) is a function that aborts the program. Such annotations are referred to as property checkers.

In FIG. 2(b), the program in FIG. 2(a) is annotated with array out-of-bounds checkers at P1 and P2. The variables a_lo and a_hi refer to the lowest and the highest possible addresses for array a, respectively. Property P1 corresponds to the underflow out-of-bounds error, while property P2 corresponds to the overflow out-of-bounds error.

As a next step, the annotated program is analyzed by a static analyzer, which uses various dataflow algorithms ranging from simple constant folding to more complex numerical analysis algorithms such as intervals, octagons, polyhedra, and disjunctive numerical domains to compute state invariants for all the statements in the program. A safety property S,φ is proved by the static analyzer if the invariant ψ computed at label S is such that ψ [symbol] φ is false.

For the program in FIG. 2, the static analyzer computes the invariant a+i≧a_lo at P1, which implies that the underflow condition a+i<a_lo never occurs at P1. However, the static analyzer is not able to prove P2. In this case, it is because the program has an array out-of-bounds error. However, in general, the computed invariants may not be precise enough to establish the fact that a safety property is not violated in the program (even if that is the case).

Next, the Model Checker is discussed. The property checkers for the safety properties that are proved by the static analyzer are pruned away, and the resulting program is analyzed by a model checker. F-Soft performs bounded model checking to determine if any of the remaining safety properties are violated. If the model checker finds any violations, it generates an error trace showing how the property is violated. The error trace generated by the model checker is sliced with respect to the variables in the violated property, and the sliced trace is shown to the user.

Without loss of generality, the system assumes that there are only three kinds of steps in an error trace: (1) an assignment of the form x:=expr, where x is a program variable and expr is an expression in the program, (2) an evaluation of a Boolean predicate P that corresponds to a control statement, such as if, while, and for, in the program, and (3) a step representing the violation of a safety property.

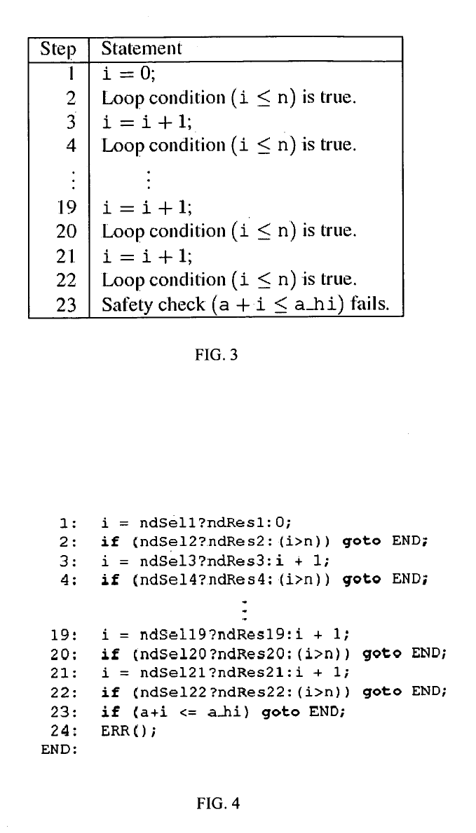

For the property P2 in FIG. 2, the model checker finds the error trace shown in FIG. 3. The statements that are not relevant to the violated property have been sliced away. In this example, the assignments to variable s have been removed from the error trace. The error trace consists of 23 steps. Steps 1,3,5, . . . , and 21 refer to the assignments to variable i, steps 2,4, . . . , and 22 refer to the evaluation of the loop condition in the program, and step 23 corresponds to violation of the property checker P2.

Next, the terminology for Proof-guided Error Diagnosis (PED) will be de discussed as the repair-based error diagnosis framework. Subsequently, improvements to the basic diagnosis using static analysis will be discussed.

An error (or error symptom) is the violation of a safety property. An error trace is a concrete trace provided by the model checker for an error. Given an error trace, the root causes of an error are the set of buggy statements or conditions that are responsible for the error. Error sites are a set of such buggy statements statements or conditions. Error Localization refers to the process of locating the error-sites. A repair solution to an error is a set of modified statements and/or conditions, i.e, fixes, that prevents the corresponding error symptom. For the program in SingleErrorTraceEx(b), the violation of the property checker P2 is an error. The root cause of the error is the buggy terminating condition i<=n (i.e., the error-site) of the “for loop”. A repair solution consists of a fix with the condition i<=n modified to i<n.

An overview of the PED tool, which is shown in PEDFlow, is discussed next. Let e₁, . . . ,eₘ be the violated safety checkers i.e., errors found by a model checker. Let T₁, . . . ,Tₘ be the corresponding error traces. Given an error trace Tⱼ, the goal of PED is to identify the statements or conditions in the program that are responsible for error eⱼ. Let p₁, . . . ,pₙ be the properties proved by the static analyzer.

Next, for the marking of untrusted code, certain statements or conditions in the program may not be error sites for a given error. For example, the assignments to s in the program in FIG. 2 may not be a root cause for the violation of the property checker at P2. On the other hand, the assignment and conditions in the error trace can not be trusted. The simplest way to determine the untrusted code is to compute a slice of all the given error traces with respect to the given safety property. The PED system can identify the statements that can be trusted using static analysis.

After identifying the trusted and untrusted code, PED creates a repair program for the given error trace.

Statements: For a trusted statement S in the error trace, the repair program has the statement S as is. For an untrusted assignment “x:=expr” at step k in a given error trace, the repair program has the following assignment:

x:=ndSel_k ? ndRes_k: expr;

Variable ndSel_k is a new non-deterministic Boolean input variable. Variable ndRes_k is a non-deterministic input variable that has the same type as the result of expr. Variable ndSel_k is referred to as a selector variable, and variable ndRes_k is referred to as the result variable.

Conditions: For a trusted condition P in the error trace, the repair program has the following if statement:

if(!P) goto END;

Label END in the goto statement refers the last statement in the repair program.

For an untrusted condition P at step k in the error trace, the repair program has the following if statement:

if(ndSel_k?ndRes_k:!P) goto END;

ndSel_k and ndRes_k are new non-deterministic Boolean input variables, !P refers to the logical negation of condition P, and END refers to the last statement in the repair program. As in the case of the untrusted assignment, variable ndSel_k is referred to as a selector variable, and variable ndRes_k is referred to as the result variable.

For a step that represents the violation of a safety condition P, the repair program has the following statement:

if(P) goto END;

Finally, a call to ERR( ) is added to the repair program after adding the statements for each step in the error trace. A call to ERR( ) aborts the program. Note that setting all the selector variables to the value in the repair program corresponds to the original error trace. Therefore, the call to ERR( ) is always reachable if is assigned to all the selector variables in the repair program.

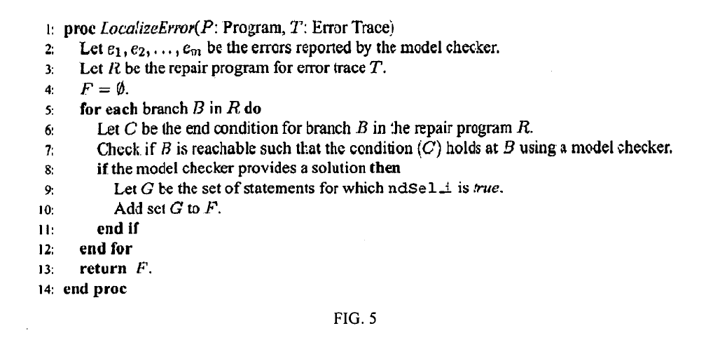

The repair program has no loops as it is based on an unrolled error trace. The if conditions in the repair program are referred to as branch statements. Also, the values of input variables in the original program are fixed based on the error trace. FIG. 4 shows the repair program for the error trace in FIG. 3. The statement at label k in the repair program corresponds to the step k in the error trace.

After creating the repair program, PED performs error localization using the algorithm in AlgLocalizeError. For a given error trace T, the algorithm creates a repair program R. The algorithm also creates the Static Single Assignment (SSA) form R′ of the repair program R, and converts R′ into a Satisfiability Modulo Theory (SMT) formula M. For each branch B with predicate P, the algorithm checks if the formula M [symbol] P (ignore D in AlgLocalizeError for now) is satisfiable using a SMT Solver. If the formula is satisfiable, the solver provides a satisfying assignment β for the formula. The satisfying assignment provided by the solver is referred to as the repair solution.

The repair solution provides a way to identify the possible root causes for an error trace. If the condition M [symbol] P is satisfied, then the assignments to the variables in the repair solution provide an execution trace of the repair program such that the predicate P is true when the branch statement B is executed. In such an execution, the call to ERR( ) is never reached because the target of the branch statement is END. In other words, the repair solution provides a way for the repair program to avoid the error.

If the value false is assigned to the selector variables in the repair program, ERR( ) is always executed. Therefore, if M [symbol] P is satisfied, at least one of the variables in the repair program has the value true. Assigning the value true to a selector variable at step k corresponds to changing the semantics of the statement at step k in the error trace. That is, changing the semantics of the statements for which the selector variable has the value true has enabled the program to avoid the error. Hence, the error localization algorithm reports these statements as possible error sites to the user. The process is repeated after adding a blocking clause [symbol] β to the condition M [symbol] P to find other error sites. Formula D represents the blocking clause for all the fixes reported by the algorithm for branch B so far. As shown in FIG. 5, the algorithm to localize error is as follows:

| | |
|---|---|
| 1: | proc LocalizeError(P: Program, T: Error Trace) |
| 2: | Let e₁,e₂,...,eₘ be the errors reported by the model checker. |
| 3: | Let R be the repair program for error trace T. |
| 4: | F = . |
| 5: | for each branch B in R do |
| 6: | Let C be the end condition for branch B in the repair program R. |
| 7: | Check if B is reachable such that the condition (C) holds |
| | at B using a model checker. |
| 8: | if the model checker provides a solution then |
| 9: | Let G be the set of statements for which ndSel i is true. |
| 10: | Add set G to F. |
| 11: | end if |
| 12: | end for |
| 13: | return F. |
| 14: | end proc |

Another embodiment of the LocalizeError is as follows:

| | |
|---|---|
| 1: | proc LocalizeError(P: Program, T: Error Trace) |
| 2: | Let R be the repair program for error trace T. |
| 3: | Let R′ be the SSA form of R. |
| 4: | Let M be the SMT formula representing R′. |
| 5: | F = . // Set of repair solutions. |
| 6: | for each branch statement B in R′ do |
| 7: | D = . |
| 8: | Let P be the predicate on the branch statement B. |
| 9: | while (M [symbol] P [symbol] D) is satisfiable do |
| 10: | Let β be the satisfying assignment. |
| 11: | H = {S\|S is a statement in R′ [symbol] the selector |
| | variable of S is true in β.} |
| 12: | Add set H to F. |
| 13: | D = D [symbol] β |
| 14: | return F. |

For the program in FIG. 2, the algorithm provides the following solution (among others): false for ndSel1, ndSel2, . . . , ndSel21, true for ndSel22, and true for ndRes22. This solution corresponds to changing the loop condition i<=n in the program such that the loop exits at an earlier step, thereby avoiding the array out-of-bound error. Therefore, i<=n is a possible error site for the violation of property P2.

Next, improvements in the error diagnosis are discussed. The basic framework, described in PED, generates all possible repair solutions. In this section, ways in which these repair solutions can be pruned to obtain the solutions that are the most relevant for debugging are discussed.

Mining Partial Specifications

The constraint solver may provide solutions that violate one or more of the safety properties proved by the static analyzer. For instance, one of the solutions provided by the constraint solver for the repair program in FIG. 4 assigns true to ndSel1 and −1 to ndRes1. While this solutions provides a fix for property P2, it violates the underflow property P1. A partial specification of the intended behavior of the program can be extracted based on the properties that are proved by abstract interpretation.

The aim of abstract interpretation is to determine the set of states that a program reaches in all possible executions, but without actually executing the program on specific inputs. To make this feasible, abstract interpretation explores several possible execution sequences at a time by running the program on descriptors that represent a collection of states. The universal set A of state descriptors is referred to as an abstract domain. Abstract interpretation is performed on a control-flow graph (CFG) of the program. A CFG G is a tuple <N,E,V,μ,n₀,φₙ_{₀}>, where N is a set of nodes, E⊂N×N is a set of edges between nodes, V is a set of variables, n₀ ε N is the initial node, φₙ_{₀} is an initial condition specifying the values that variable in V may hold at n₀, and each edge e ε E is labeled with a condition or update μ(e).

An abstract interpreter annotates each node n in the CFG with an abstract state descriptor from the abstract domain. The abstract state descriptor φₙ represents an over-approximation for the set of states that a program reaches at the node n in all possible executions. During abstract interpretation, the effects of executing an edge e ε E with label μ(e) in the program is modeled by an abstract transformer μ^{#}(e) that computes an over-approximation to the effects of executing the original statement in the program. BackwardProjection shows a CFG and the reachable states computed by abstract interpretation using the octagon abstract domain.

Next, safety projection is discussed with reference to n ε N, n_{S},φ be a safety property, and P be the set of paths from n to n_{S} in CFG G. The safety projection of a property n_{S},φ onto a node n, denoted by χₙ is the disjunction of the weakest preconditions of φ with respect to every path in P: χₙ= [symbol] _{pεp}WP(p,φ), where WP(p,φ) is the weakest precondition of φ with respect to the path p.

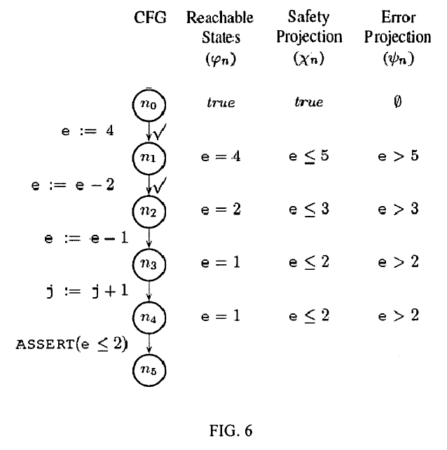

The safety projection of a property n_{S},φ onto a node n represents the set of states at n that cannot reach an error state at node n_{S}. For instance, consider the safety projection of property n₄,e≦2 onto node n1 shown in FIG. 6. If the value of e at node n1 does not satisfy the safety projection condition e≦5, then the assertion at node n₄ fails. Therefore, the safety projection of a property provides a constraint on the set of permissible values for the variables at every node in the CFG, which is a partial specification of the intended behavior of the program. To improve the quality of the repair solutions provided by the error localization algorithm, the system computes the safety projections for each property that is proved by the static analyzer and use them as invariants to constrain the values of the result variables in the repair program.

For the program in FIG. 4, abstract interpretation based on the interval domain gives the following constraints for the non-deterministic result variables: 0≦ndRes1≦10, −1≦ndRes3≦10, −1≦ndRes5≦10, . . . , −1≦ndRes22≦10. These constraints prevent the constraint solver from picking −1 for variable ndRes1. Consequently, the-constraint solver does not provide a solution that violates the safety property.

Next, the mining of relevant invariants is discussed. As there may be an infinite number of paths in the CFG, computing the exact safety projection is not computationally feasible. Therefore, the system computes an over-approximation to the safety projection of n_{S},φ at each node using abstract interpretation. First, a new CFG G′=N,E′,V,μ′,n_{S}, [symbol] φ is created from the CFG G=N,E,V,μ,n₀,φ₀ of the program. The set of edges in G′ is such that (n,m) ε E′ if (m,n) ε E, i.e., the edges in G are reversed in G′. Every edge (n,m) ε E′ is labeled with the weakest precondition operator for the update or condition μ(m,n) ε G. The initial node for G′ is n_{S}, and the initial condition for G′ is the safety condition φ. The abstract value χₙ^{#} computed at a node n ε N by performing abstract interpretation on G′ represents an over-approximation for the safety projection χₙ·χₙ^{#} is used as invariant to constraint the values of the result variable at node n.

Because χₙ^{#} is an over-approximation to the actual safety projection χₙ, χₙ^{#} may include states at n that lead to the violation of φ at n_{S}. Therefore, it is not guaranteed that constraint solver will never provide a solution that violates the property. However, the constraints on the values of non-deterministic result values obtained as outlined above works well in practice. On the set of benchmarks described in Experiments, the number of error sites reported by the error localization algorithm is substantially reduced.

Next, the mining for trusted code is discussed. For more restrictive repair solutions, the system identifies program statements that are relevant for the static proofs, and mark them as “trusted”. The idea is not to modify the trusted statements in repair program, and restrict the repair solutions to untrusted program statements. In the following, relevant edges are defined and how relevant statements are obtained will be discussed.

In error projection, for n ε N, <n_{S},φ> is a safety property, and P is the set of paths from n to n_{S} in the CFG. The error projection of a safety property <n_{S},φ> onto a node n, denoted by ψₙ is the disjunction of the weakest preconditions of [symbol] φ with respect to every path in P: ψₙ= [symbol] _{pεP}WP(p, [symbol] φ), where WP(p, [symbol] φ) is the weakest precondition of [symbol] φ with respect to the path p.

The error projection of a property <n_{S},φ> onto a node n represents the set of states at n that reach an error state at node n_{S}. For instance, consider the error projection of property n₄,e≦2 onto n1 shown in FIG. 3, which is an exemplary diagram that shows reachable states, error projection, and safety projection for the property n₄,e≦2. √ refers to the relevant edges.

If the value of e satisfies the error projection condition e>5, then the assertion e≦2 at node n4 fails. Just as safety projections provide constraints on the values of the result variables in the repair program, error projections provide constraints on the values of the selector variables in the repair program. Analogous to safety projections, abstract interpretation can be used to compute an over-approximation for the error projection at each node in the program.

For relevant edges, <n_{S},φ> is a safety property that is proved by static analysis, φₙ is the invariant at node n computed by static analysis on G and ψₙ is the error projection of n_{S},φ onto node n. An edge m→n ε E is relevant if the following holds:

(φₘ [symbol] ψₙ=Ø) [symbol] (φₘ [symbol] ψₙ≠Ø) (1)

The conjunct (φₙ [symbol] ψₙ=Ø) encodes the fact that error state is not reachable from the node n. The conjunct (φₘ [symbol] ψₙ≠Ø) encodes the fact that the error state is possibly reachable from n if the transition for m→n is treated as an identity transformer (as φₙ becomes same as φₘ). For the CFG in FIG. 6, edge n₁→n₂ is relevant because Eq. 1 holds. For n₁→n₂, φₙ_{₁}:e=4, φₙ_{₂}:e=2, ψₙ_{₁}:e>4, and ψₙ_{₂}:e>3. Consequently, φₙ_{₂} [symbol] ψₙ_{₂}=Ø and φₙ_{₁} [symbol] ψₙ_{₂}≠Ø. In FIG. 6, only edges n₀→n₁ and n₁→n₂ are relevant.

The relevant edges provide a simple and efficient way to identify the transitions that are important for the static analyzer to prove a given safety property.

If μ(m→n) is replaced with the identity transformer in a modified CFG G′, then φₘ⊂_{A}φ_{m′}=φ_{n′}, where φ_{m′} and φ_{n′} refer to the invariants computed at node m and n, respectively, in G′. Further, φₙ_{_{S}}φₙ_{_{S}}′. For a given G if all μ(m→n) are replaced with identify transformers to obtain a modified CFG G′, the static analyzer may no longer find the proof for the safety checker, i.e., φₙ_{_{S}} [symbol] φ=Ø may not hold.

As φₙ_{_{S}}′ gets larger, it may likely contain the error state, and therefore, a static proof may not hold in G′. On the other hand, a static proof may still hold in G′ if an edge that is not relevant in G has become relevant in the modified G′. This can happen when for some edge a→b, the following condition holds (inadequacy condition): ψ_{b}=Ø in G, but ψ_{b′}≠Ø in G′.

Based on the foregoing, one can obtain a set of adequate relevant edges, by identifying all the relevant edges in a CFG and replacing the corresponding abstract transformers with the identity transformers in the modified CFG, and iterating the process on the modified CFG until inadequacy condition does not hold. However, for error diagnosis, the system does not need adequate set of edges, though such a set would give a more precise result. For efficiency reasons, the system chooses a single iteration to obtain the relevant statements from a given CFG, and mark the relevant statements as “trusted”. Trusted statements are not modified in the repair program.

For the repair program in FIG. 3, the assignment “i=0” at step 1 is marked as relevant. Therefore, the error localization algorithm does not report the statement “i=0” as an error site. This is an improvement over specifying only constraints on the result variables. In the previous case, the error localization algorithm may report “i=0” as a possible error site.

### Annotation Library

In the program shown in FIG. 4, the constraint solver may choose true for the result variable at any branch in the execution of the program. That is, the error is avoided trivially by cutting the execution of the program at any arbitrary branch. Such behavior causes the error diagnosis algorithm to report useless repair solutions.

To avoid this problem, an annotation library is used. Instead of blindly replacing the expressions with new non-deterministic variables, the system relies on a library of possible replacements for the operators and expressions in the program. For a particular kind of error, programmers typically make the same kind of mistakes. For instance, a majority of the array out-of-bound violations are typically caused by one of the following kinds of errors: (1) using the ≦ operator instead of < operator, i.e., off-by-one errors, (2) using an incorrect variable as the upper bound for an index, such as using i<m instead of i<n, and (3) errors caused by copy-paste operations. An example of the annotation library is as follows:

| Operator | Alternatives (weight) |
|---|---|
| ≦ | <(30), ≧(20), >(10) |
| < | ≦(30), >(20), ≧(10) |
| > | ≧(30), <(20), ≦(10) |
| ≧ | >(30), ≦(20), <(10) |

The numbers in the parenthesis are weights that refer to the relative preference among the alternatives. The operator with higher weight is preferred over another operator with lower weight. For instance, < is the most preferred alternative for the ≦ operator. Suppose that annotation library given above is used, the condition i<=n at step k of FIG. 3 would be replaced with the condition

(ndSel_k=3)?(i<n):

((ndSel_k==2)?(i>=n):

((ndSel_{—k==}1)?(i>n):(i<=n)))

instead of ndSel_k?(ndRes_k):(i<=n).

In one embodiment, the annotation library is manually populated by an expert, based on the knowledge of the problem domain. In other embodiments, the library is automatically by using machine learning or data mining techniques based on the information from CVS logs or fixes made by the programmer for other bugs.

When an annotation library is provided, one embodiment of the system uses the weighted max-sat algorithm (implemented in SMT solver as such) to determine if M [symbol] P [symbol] D is satisfiable at step 1 of the error localization algorithm shown in FIG. 5. The weights provided in the annotation library are used as weights in the max-sat algorithm for the constraints that choose an alternative. For instance, using the annotation library shown earlier, weight 30 is assigned to the constraint ndSel_k=3, weight 20 is assigned to the constraint ndSel_k≧2, and weight 10 is assigned to the constraint ndSel_k>3. With these weights, the SMT solver is more likely to find a solution that satisfies ndSel_k=3. Therefore, an operator is replaced with its most preferred alternative.

Next, exploiting correlation to improve performance is discussed. For repeating statements, a repair program can be generated from an unrolled error trace with multiple copies of the statements in a loop and therefore, a repair program may have multiple copies of a statement that occurs in a loop. In the scheme described in PED, a different non-deterministic selector variable is used for every statement. Therefore, the error localization algorithm may provide repair solutions that make changes to the such statements inconsistently. For instance, the algorithm provides a solution in which the statement i=i+1 is changed in one step of the error trace, but not in another step. Such repair solutions are not useful because a change to the semantics of a statement in a loop has to be applied consistently across all executions steps of the statement in the loop. Therefore, constraints are added so that the SMT solver chooses a consistent value for the non-deterministic selector variables associated with the statements that are repeated in the trace.

For the repair program in FIG. 4, the following constraints are added:

(ndSel2=ndSel4 . . . =ndSel22)

[symbol]

(ndSel3=ndSel5 . . . =ndSel21)

In one implementation, the equalities are simplified and propagated to reduce the formula size. However, similar constraints can not be done for the result variables of the statements in a loop, because the result of the computation at each loop step can be different.

For use-def chains, for the following repair program (comments show the use-def chain in the original program):

x = ndSel1?ndRes1:e; // x = e;
....
y = ndSel2?ndRes2:x; // y = x;
....

As a repair solution ndSel1=true and ndSel2=true, does not propagate the repair effect of x to y, the constraint ndSel1=true [symbol] ndSel2=false is added to avoid a redundant repair solution.

Additionally, other improvements can be done. Multiple error traces for a single error can be used to improve error localization. A bug is typically manifested as multiple error traces for violations of one or more safety checkers. With the following simple C program fragment:

N1: x = 0;
if( ) {N2: x = x + 2;}
else {N3: x = x + 3;}
N4:if(x > 1) ERR( );

the program reaches an error state, because the condition x>1 at N4 is always satisfied. The model checker provides two error traces: (1) N1→N2→N4 and (2) N1→N3→N4. If error trace (1) is examined in isolation, the error localization algorithm provides a solution that suggests that either N1 or N2 or both need to be fixed. Similarly, if error trace (2) is examined in isolation, the error localization algorithm provides a solution that suggests that either N1 or N3 or both need to be fixed. In either case, changing N1 is the best fix because it fixes both the error traces. But, it is not possible to arrive at this conclusion by examining the error traces in isolation. Taking the intersection of the fixes suggested by the error localization algorithm for the different error traces gives N1 as the only fix. Therefore, with multiple error traces, the system takes the intersection of the fixes for each error trace.

Limiting the number of changes Typically, it would only require a few changes to the program to fix the error. When finding repair solutions, t he system adds constraints that bound the number of selector variables that can be assigned true by the solver. By adding such constraints, the error localization algorithm may be directed to find solutions that only require a minimal number of changes to the original program.

Next, the ranking of the repair solutions is discussed. The error localization algorithm provides several repair solutions to avoid the error. However, all the fixes provided by the tool may not be relevant to the error. Therefore, a ranking mechanism is used to prioritize the repair solutions.

First, the repair solutions are sorted by the number of steps in the execution of the repair program using the assignments from the repair solutions. The error localization algorithm provides repair solutions that skip to the END statement at any of the branches in the repair program. This criterion gives preference to the repair solutions that do not skip large parts of the repair program.

After sorting on the number of steps, the repair solutions are sorted by the number of fixes suggested by error localization algorithm. The intuition behind this criterion is that the programmer would prefer to look at lesser number of error sites when debugging.

Finally, the repair solutions are sorted by the number of fixes to non-loop statements. That is, repair solutions that have more fixes in non-loop statements are given higher preference. The idea behind this criterion is that the fixes to non-loop statements change the semantics of only fewer steps in the program. However, the fixes to loop statements change the semantics of several steps in the program.

These ranking criteria were obtained based on the experience with using PED on a set of publicly available benchmarks. While the criteria are good enough for the set of benchmarks, it may not necessarily be good for other applications. The ranking scheme can be generalized by adapting ranking methods that are based on statistical analysis and user feedback.

### Experimental Tests

To evaluate the effectiveness of the error localization algorithm, the algorithm was tested on a collection of programs from the Verisec benchmark suite. The Verisec benchmark suite is a collection of programs that include the functions extracted from popular open source programs with known buffer-overrun vulnerabilities. The statements in the program that cause the buffer overflow are also known. The error localization algorithm was tested with different settings on the benchmark programs to evaluate the usefulness of the improvements described in the paper. For the experiments, the maximum number of fixes reported by the tool was set to 250, and an annotation library was also used. The system used YICES SMT solver (version 1.0.10) in the PED tool on a workstation with Intel QuadCore 2.4 GHz, 8 GB of RAM running Linux.

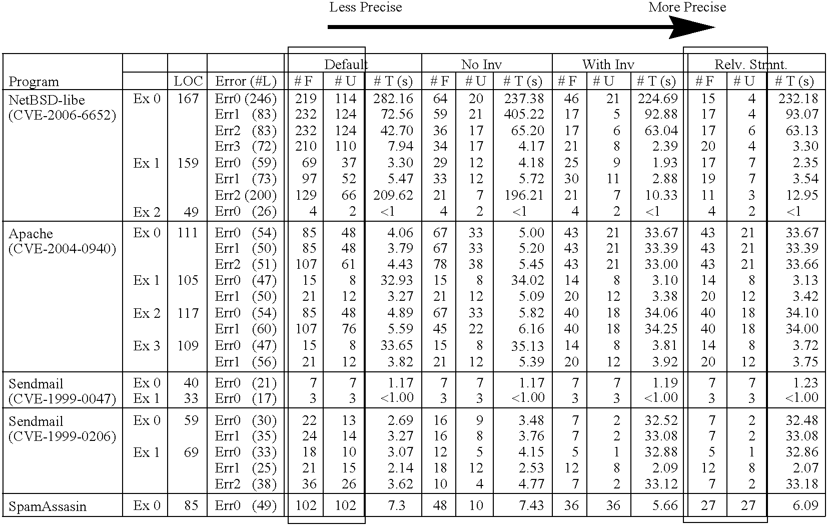

#F: number of reported root causes
#U: number of reported root causes that include the actual error site

In Table 5, the column labeled “Default” refers to the basic error localization algorithm described in PED. The column labeled “No Inv” refers to the algorithm with only the improvements from ExploitingCorrelationOtherImprovements. The column labeled “With Inv” refers to the algorithm with the invariants extracted using the results of static analysis as described in FindingTrustedCode along with the improvements used for “No Inv”. The column labeled “Relv. Stmnt.” refers to the run of the algorithm with the information about the relevant statements obtained from static analysis as described in FindingTrustedCode along with the improvements used for “With Inv”. The column “# F” represents the number of fixes reported by the tool. The column labeled “# U” represents the number of fixes that included the known error site. Effectively, the “# U” column shows how much of the fixes reported by the tool are useful. The column labeled “# T(s)” represents the time taken by the solver to find the reported fixes in seconds.

When the improvements described above are used, the number of fixes reported by the tool is substantially reduced. The number of fixes reported by the tool without the improvements is 2 to 3 times the number of fixes reported with the improvements. The advantage of having a lesser number of fixes is that the user of the tool only has to look a smaller number of fixes to identify the root cause of the bug.

Similarly, the number of fixes reported by the tool is substantially reduced if the relevant invariants extracted from static analysis is used to add constraints on the non-deterministic result variables. Also, when the information about relevant statements is used, the number of fixes is reduced to less than one-third the number of fixes reported without the information about relevant statements. (The examples for which “Relv. Stmnt.” shows improvements over “With Inv” is highlighted in bold in Results.)

When the improvements described above are used, the error localization algorithm only reports the most relevant fixes. Further, the ranking scheme is effective for the examples. When the fixes provided by the tool for the configuration “Relv. Stmnt.” are reviewed, the buggy statement was reported in one of the first five fixes.

In sum, the proof-guided error diagnosis framework based on repair approaches and techniques described above improve existing approaches by taking into account information, such as relevant invariants and relevant statements from proofs in static analysis, syntactic closeness of operators, correlation among statements, and multiple error traces to improve error localization. Such an approach improves the quality of error diagnosis. It is contemplated that machine learning can be used to obtain the annotation library automatically from CVS logs to improve the localization even better.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A computer implemented method of diagnosing errors in a program, comprising:
from one or more error traces, building a repair program containing one or more modified program semantics corresponding to fixes to observed errors;
encoding the repair program with constraints, biases and priortization into a constraint weighted problem; and
solving the constraint weighted problem to generate one or more repair solutions, wherein the encoding includes at least one of:
a) constraining one or more repairs choices guided by automatically inferring one or more partial specifications of intended program behaviors and program structure;
b) biasing one or more repair choices guided by typical programming mistakes; and
c) prioritizing the repair solutions based on error locations and possible changes in program semantics.

2. The method of claim 1, wherein the program includes an original right hand side expression and an original conditional expression and wherein the building of the repair program comprises:
replacing a right hand side expression of a program assignment statement with a select expression that chooses non-deterministically the original right hand side expression or a non-deterministic value of a same return type; and
replacing a conditional expression of a program condition statement with a select expression that chooses non-deterministically the original conditional expression or a non-deterministic Boolean value.

3. The method of claim 2, comprising restricting replacement of the program statements to one or more program statements relevant to predetermined error traces.

4. The method of claim 2, comprising restricting replacement of the program statements to one or more program statements that do not affect partial specification of the program.

5. The method of claim 2, comprising constraining replaced program statements repeating in a loop to allow only same or no change(s) in respective program semantics.

6. The method of claim 2, comprising constraining the replaced program statements appearing in a use-def chain to disallow simultaneous change(s) in respective program semantics.

7. The method of claim 1, wherein the partial specifications are derived from proofs obtained by static program analysis for standard safety checkers.

8. The method of claim 1, wherein the biasing of repair choices comprises directing a search based on syntactic closeness of an operator mapping.

9. The method of claim 8, comprising determining closeness of operator by the logs of typical mistakes made by one or more programmers.

10. The method of claim 1, wherein the encoding comprises obtaining a quantifier free first order formula.

11 The method of claim 1, comprising applying a constraint solver to obtain one or more solutions for the constraint weighted formula.

12. The method of claim 1, wherein each repair solution comprises one or more repair locations with corresponding changes in program semantics.

13. The method of claim 1, wherein the repair solutions are prioritized based on one or more of the following:
a) a proximity of a repair location with respect to one or more error symptoms;
b) an intersection of repair solutions corresponding to one or more errors symptoms;
c) number of repair locations for each solution;
d) a repair location being inside a loop or not.

14. The method of claim 1, wherein one or more partial specifications are considered unreliable when no repair solutions are generated.

15. A system to diagnose errors in a computer program, comprising:
a processor; and
a data storage device coupled to the processor to store computer readable code to encode a repair program with constraints, biases and priortization into a constraint weighted problem; and solving the constraint weighted problem to generate one or more repair solutions, wherein the encoding includes at least one of:
a) constrain one or more repairs choices guided by automatically inferring one or more partial specifications of intended program behaviors and program structure;
b) bias one or more repair choices guided by typical programming mistakes; and
c) prioritize the repair solutions based on error locations and possible changes in program semantics.

16. The system of claim 15, wherein the program includes an original right hand side expression and an original conditional expression and wherein the code to building of the repair program comprises code to:
replace a right hand side expression of a program assignment statement with a select expression that chooses non-deterministically the original right hand side expression or a non-deterministic value of a same return type; and
replace a conditional expression of a program condition statement with a select expression that chooses non-deterministically the original conditional expression or a non-deterministic Boolean value.

17. The system of claim 15, comprising restricting replacement of the program statements to one or more program statements relevant to predetermined error traces.

18. The system of claim 15, comprising restricting replacement of the program statements to one or more program statements that do not affect a partial specification of the program.

19. The system of claim 15, comprising code to constrain replaced program statements repeating in a loop to allow only same or no change(s) in respective program semantics.

20. The system of claim 15, code to constrain the replaced program statements appearing in a use-def chain to disallow simultaneous change(s) in respective program semantics.

21. The system of claim 15, wherein the partial specifications are derived from proofs obtained by static program analysis for standard safety checkers.

22. The system of claim 15, wherein the code to bias repair choices comprises code to direct a search based on syntactic closeness of an operator mapping.

23. The system of claim 22, comprising code to determine closeness of operator by logs of typical mistakes made by one or more programmers.

24. The system of claim 15, wherein the encoding code comprises obtaining a quantifier free first order formula.

25. The system of claim 15, comprising code to apply a constraint solver to obtain one or more solutions for the constraint weighted formula.

26. The system of claim 15, wherein each repair solution comprises one or more repair locations with corresponding changes in program semantics.

27. The system of claim 15, wherein the repair solutions are prioritized based on one or more of the following:
a) a proximity of a repair location with respect to one or more error symptoms;
b) an intersection of repair solutions corresponding to one or more errors symptoms;
c) the number of repair locations for each solution; and
d) a repair location being inside a loop or not.

28. The system of claim 15, wherein one or more partial specifications are considered unreliable when no repair solutions are generated.
